(19) United States
(12) Patent Application Publication
(10) Pub. No.: US 2014/0149054 A1
(43) Pub. Date: May 29, 2014

(54) Leak Detection Via a Stochastic Mass Balance

(71) Applicants: Holger Hanss, Germersheim (DE); Kurt Majewski, Muenchen (DE); Roland Rosen, Herrsching (DE); Jan Christoph Wehrstedt, Muenchen (DE)

(72) Inventors: Holger Hanss, Germersheim (DE); Kurt Majewski, Muenchen (DE); Roland Rosen, Herrsching (DE); Jan Christoph Wehrstedt, Muenchen (DE)

(21) Appl. No.: 14/129,008

(22) PCT Filed: Jun. 13, 2012
(86) PCT No.: PCT/EP2012/060963

§ 371 Date: Dec. 23, 2013

(30) Foreign Application Priority Data
Jun. 28, 2011 (DE) DE 102011078240.0

(51) Int. Cl. G01N 35/00

(52) U.S. Cl. CPC G01N 35/00
USPC 702/35

(57) ABSTRACT

A method, device and assistance system for detecting leaks in an area of a supply network, wherein leaks are detected by comparing real measured values supplied by sensors with measured values ascertained using a Monte Carlo simulation and, in particular, the method ascertains irregularities, which can be attributed to anomalies such as leaks, based on a hydraulic analysis so that existing leaks can be detected. Furthermore, the method can be applied to sensors that are temporarily installed in the network, giving the network operator additional freedom in the leak detection, and can be used for other supply networks and infrastructures.

### REFERENCE TO RELATED APPLICATIONS

This is a U.S. national stage of application No. PCT/EP2012/060963 filed 11 Jun. 2012. Priority is claimed on German Application No. 10 2011 078 240.0 filed 28 Jun. 2011, the content of which is incorporated herein by reference in its entirety.

### BACKGROUND OF THE INVENTION

1. Field of the Invention

The present invention relates to a method and an apparatus for detecting leaks in an area of a supply network and to implementing the method in a supply network.

2. Description of the Related Art

Drinking water has by now become one of the most important goods in the 21st century. However, sometimes considerable water losses occur in water distribution networks.

The conservation of this goods item is a great challenge for detecting and locating leaks in water networks. The practice of detecting water losses via a mass balance, in which all feed-in quantities and, in particular, the water consumption quantities of all individual water consumers are measured, exceeds the limits of feasibility in terms of effort. Furthermore, legal situations hamper precisely timed consumption measurements and consumption recordings of all customer data.

In order to detect leaks in water networks, only the entire quantity of water flowing into the network is conventionally measured at a particular time, such as the period between 2 and 4 in the morning. These values produce a time series that is analyzed to determine whether there is a sudden rise in consumption and therefore a possible leak. It is not conventionally possible to balance the consumptions of the system. There are empirical formulas for the typical water consumption of particular consumers. However, these formulas are very general and cannot take into account, in particular, time-limited special effects with sufficient accuracy.

The usually very large water supply networks are commonly subdivided into water supply zones. These zones are in turn subdivided into subzones which are referred to district meter areas (DMA) because they are coined by British engineers. The DMAs are created such that they have only one inflow, the flow rate of which is measured. Irregularities in the water consumption and therefore leaks are inferred from the observation of this flow measurement. Specifically, a so-called “night flow analysis” is conventionally performed. In this case, detailed recording of the nightly inflow values into a DMA (such as every 5 seconds between 2:00 and 4:00) is used to determine a minimum inflow value (also referred to as background consumption here) which comprises the normal nightly (minimum) consumption and existing (in particular also small) leaks.

A time series is created over days and weeks based on these minimum inflow values into a DMA during low-consumption night-time hours, such as between 2 and 4 a.m., in which case only one value per night is then provided. The, in particular sudden, rise in these minimum consumption values, which can be detected by a threshold value being exceeded, for example, may be caused by a new leak.

In order to locate a leak, a step test is usually performed. For this purpose, small regions are gradually separated from the DMA at low-consumption times and the change in consumption is observed. Regions that result in a severe inexplicable decrease in consumption are then examined further for leaks.

Alternatively, noise meters can be used to listen to the water system in situ for leaks and the leak point can be calculated by considering the noise correlation.

Both of these conventional methods are not suitable for permanent monitoring. Step tests are associated with a large amount of effort because the affected households must be informed of the disconnection and a backup supply must be ensured. Noise measurement requires a large amount of expenditure because the measurements can be performed only by specialists in situ. In addition, these investigations are always only locally possible. In addition, both conventional methods can be used only in low-consumption times so that the measurements are not overly disrupted by consumption fluctuations.

### SUMMARY OF THE INVENTION

It is therefore an object of the present invention to provide a method and an apparatus for detecting leaks in an area of a supply network, where leaks in the supply network are detected with a high degree of probability.

This and other objects and advantages are achieved in accordance with the invention via a computer-aided method for detecting leaks in an area (DMA) of a supply network comprising:
a) installing flowmeters in a stationary manner at inflows and outflows of the area (DMA);
b) installing sensors for determining the flow rate or the water pressure within the area (DMA);
c) determining the water consumption for the area (DMA) within one or more stipulated measuring periods via the flowmeters at the inflows and outflows and the measured values from the sensors within the area (DMA);
d) mapping the topology of the supply network in a hydraulic simulator and creating a hydraulic simulation model for the area (DMA);
e) determining the consumptions within the area (DMA) via random stipulation using the consumption profiles and the inflows and outflows of the area (DMA);
f) calculating the flow behavior and pressure behavior in the supply network within one of the stipulated measuring periods via Monte Carlo simulation; and
g) determining whether there is a leak by comparing the results determined by the Monte Carlo simulation with measured values provided by the sensors within the area (DMA).

In accordance with the method of the invention, a distinction is made between flow sensors at the inflows and outflows and sensors within the area. Whereas the measured values from the inflow and outflow sensors describe the water consumption of the area and are therefore used in the hydraulic model, the measured values from the internal sensors are used to determine differences between the model and reality and are therefore used to detect leaks. The consideration of a plurality of measuring intervals compensates for a random atypical consumer behavior so that the latter is not overrated. The method can be easily automated (by using computers and corresponding software) and can be operated together with other methods which consider each area separately (such as camera monitoring or pressure sensors). Dynamic, non-periodic special effects (such as higher water consumption during sports events on the television) can also be taken into account, as a result of which the false alarm rate also continues to be reduced. The method can also be used for areas in which the night flow analysis cannot be used because high consumptions also occur at night, such as in megacities.

In a first advantageous embodiment of the invention the areas (DMA) may also be virtual district meter areas. Virtual zones or virtual district meter areas (DMA) are subareas of a network, the inflows and outflows of which are measured via flowmeters, in which case there is no requirement for the areas to be disjoint. The time series for all areas are gradually evaluated and leaks in the areas are detected. The location of the leak is then narrowed down using the leak information for the individual areas. An item of leak information is an item of information relating to whether or not a leak has been detected in the area. Virtual district meter areas (virtual DMAs) differ from conventional areas (DMAs) as follows. When subdividing zones into DMAs, an attempt was always conventionally made to form these DMAs such that only one inflow or inflow pipe resulted and can be monitored using a single sensor. In the supply zones, additional flow sensors are installed at selected points such that parts of the network result, the inflows and outflows of which can be measured. These parts should have a common element. The parts are intended to be superimposed and to have common flowmeters. Such parts are referred to as virtual zones or virtual DMAs.

In another advantageous embodiment of the invention the measuring period is, for example, from 2:00 to 4:00, from 0:00 to 24:00 and/or from 6:00 to 18:00. During a night flow analysis, all flowmeters or sensors are used to measure the flow rate within the scope of such an analysis at night, such as between 2:00 and 4:00, i.e., during times which usually have a low consumption. Instead of an analysis at night, other intervals of time, such as 24 hours or a plurality of measuring periods during a day, may be considered for integrated flow analyses.

In another advantageous embodiment of the invention step e) of determining the random consumptions of the consumers connected in the areas (DMA) is performed using the sequence of the following method steps:
1. classifying the consumers based on an associated average daily consumption;
2. determining a theoretical total consumption for each consumer based on the respective average daily consumption and the consumption determined within the stipulated measuring period;
3. stipulating a quantity of water Q that is considerably smaller than the minimum water consumption in an area (DMA) and setting the consumption to 0 (initialization) for all consumers in the supply network;
4. dividing the stipulated measuring period into periods of time and measuring the total consumption per area (DMA) in each period of time;
5. randomly selecting consumers for each period of time and increasing the consumption of the randomly selected consumers by the stipulated quantity of water Q in a respective period of time;
6. return to step 5) as long as the total water consumption distributed for an observation period is smaller than the consumption determined in step 4);
7. repeat steps from 4) onward until all periods of time have been processed.

This algorithm is used to describe the consumption distribution. A hydraulic simulation of the network section is performed using this consumption. For a hydraulic simulation, boundary conditions must be set such that the physical model is meaningfully described: if the zone has only one inflow/outflow, a constant pressure is set at this point, and, if the zone has a plurality of inflows and outflows, a constant pressure is set at one of them and the measured inflows and outflows are set at the others. The mass balancing in the model is therefore correct.

In yet another advantageous embodiment of the invention step e) of determining the random consumptions of the consumers connected in the areas (DMA) is performed using the sequence of the following method steps:
I. stipulating n consumption nodes in the supply network;
II. stipulating a quantum quantity Q that is considerably smaller than the minimum water consumption in an area (DMA);
III. stipulating a measured total consumption R as an integer multiple of the quantum quantity Q;
IV. stipulating the sum G of the average consumptions V(n) of all nodes;
   for all consumption nodes n, until the value X(n) is determined for each node n:
V. select the next consumption node n which has not yet been dealt with and has an average consumption v(n);
   pick the random variable X(n) with a value between 0 and R and the distribution P(X(n)=k)=V(n)^{k}*(G−V(n))^{(R-k)}*R!/(G^{R}*k!*(R−k)!);
   replace G with G−V(n) and R with R−X(n).

Alternatively, the random flows may also be distributed to the consumers using the algorithm illustrated, if it is known that the consumption profiles of the consumers in an area are the same. This is equivalent to the first embodiment of the method, but is distinguished by a lower delay time since fewer random numbers are picked.

In a further advantageous embodiment of the invention steps e) and f) are repeated for a fixed interval of time and the calculation results are averaged before the comparison according to step g) occurs. A fluctuation range for the calculation results is obtained as a result of the repetition. The influence of outliers is reduced in this case and the normal behavior of the area emerges.

In another advantageous embodiment of the invention, the method is implemented for an infrastructure network for transporting a fluid. The measured values for fluids can be easily and accurately determined by means of corresponding sensors (such as pressure or flow sensors) and can therefore be used for reliable predictions.

In still a further advantageous embodiment of the invention, the infrastructure network is a water supply or a gas supply or a district heating network. The disclosed embodiments of the invention can be used for all infrastructure networks in which fluids are transported and consumed. Examples of such infrastructure networks are gas supply and district heating networks.

It is also an object of the invention to provide a computer-aided apparatus for implementing the method for detecting leaks in an area of a supply network, where the apparatus comprises:
a) sensors for measuring a respective minimum inflow for each area (DMA) within a stipulated measuring period;
b) means for determining the water consumption for each area (DMA) within a stipulated measuring period by means of the installed sensors;
c) means for mapping the topology of the supply network in a hydraulic simulator and creating a hydraulic simulation model for each area (DMA);
d) means for determining the consumption profiles of the consumers connected in the areas (DMA);
e) means for determining the flow behavior in the supply network within the stipulated measuring period via Monte Carlo simulation; and
f) means for determining whether there is a leak by comparing the measured values determined by the Monte Carlo simulation with the measured values provided by the sensors. The apparatus can be produced using commercially available means. For example, the corresponding sensors are available in corresponding hardware stores, the means for mapping the topology, for determining the consumption profiles and for determining the flow behavior and the means for comparing the actual measured values with the measured values determined by the Monte Carlo simulation can be implemented on personal computers and corresponding software (such as table calculation, mathematical programs, or simulation programs).

In another advantageous embodiment of the invention, output means are provided for presenting the comparison of the measured values determined by the Monte Carlo simulation with the measured values provided by the sensors and/or for presenting indicators of a leak. A graphical representation makes it possible to visually compare the results and to easily detect discrepancies as indicators of leaks.

It is also an object to provide a computer-aided simulation-based assistance system for detecting leaks in an area of a supply network, where measured values are recorded by sensors installed in a stationary manner for measuring a minimum inflow of the area within a stipulated measuring period and are transmitted to an evaluation device via remote data transmission,

The evaluation device includes:
means for determining the water consumption for each area within a stipulated measuring period via the installed sensors;
means for mapping the topology of the supply network in a hydraulic simulator and creating a hydraulic simulation model for each area (DMA);
means for determining the consumption profiles of the consumers connected in the areas;
means for determining the flow behavior in the supply network within the stipulated measuring period via Monte Carlo simulation; and
means for comparing measured values determined by the Monte Carlo simulation with the measured values provided by the sensors to detect possible leaks in an area in the event of discrepancies. The computer-aided assistance system can be produced using commercially available means. For example, the corresponding sensors (such as flowmeters) are available in corresponding specialist shops, and the means for calculating can be implemented on personal computers and corresponding software (such as table calculation, mathematical or simulation programs). If a leak is detected, the assistance system can automatically initiate suitable countermeasures (e.g., stopping the inflow to an area, or initiating suitable measures) or can suggest the countermeasures to the operating personnel. The assistance system is suitable, in particular, for use in a control room for monitoring a supply network.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

One exemplary embodiment of the invention is illustrated in the drawings and is explained below, in which

FIG. 1 shows exemplary embodiments of areas in accordance with the invention;

FIG. 2 shows an exemplary basic illustration of a supply network with an assistance system;

FIG. 3 shows an exemplary illustration of sensor measured values and calculated values for detecting a leak; and

FIG. 4 shows an exemplary flowchart for performing the method in accordance with the invention.

### DETAILED DESCRIPTION OF THE PREFERRED EMBODIMENTS

The reduction of water losses is a great challenge for detecting and locating leaks in water networks. In subareas of a network, water losses can be detected via flow rate measurements at all inflows and outflows of the area and formation of a mass balance.

Such measurements exceed the limits of feasibility both in terms of effort and in terms of the legal situation (precisely timed consumption measurement and recording of all customers may result in problems in terms of data protection law). Nevertheless, new more favorable measuring devices make it possible to monitor physically relevant values, such as pressure or flow rate.

The present invention presents a stochastic model for consumers in a supply network, which model makes it possible to set up a network-wide mass balance using a hydraulic simulation to detect both new and already existing leaks.

The usually very large water supply networks are subdivided into water supply zones (areas). These areas may in turn be subdivided into subzones that are referred to as district meter areas (DMA) because they are coined by British engineers. The DMAs are created such that they each have only one inflow, the flow rate of which is measured. Alternatively, instead of physical DMAs, it is also possible to use virtual zones which may have a plurality of inflows and outflows. Irregularities in the water consumption and therefore leaks are inferred from the observation of the flow measurement. Specifically, a night flow analysis is performed. A DMA is performed using the minimum inflow values during low-consumption night-time hours, such as between 02:00 and 04:00. With one value per night, a time series is created over days and weeks. The (sudden) rise in these minimum consumption values, which can be detected by a threshold value being exceeded, for example, may be caused by a new leak.

Special events, such as the use of lawn sprinklers, sports events or customs during the night measurement therefore cause an increase in the minimum inflow into different DMAs. An alarm is therefore triggered for all DMAs. Such a possible false alarm hitherto had to be detected by the user of the system and eliminated via further analysis. The present invention allows an automatic method for detecting network-wide events for reducing false alarms during leak analysis.

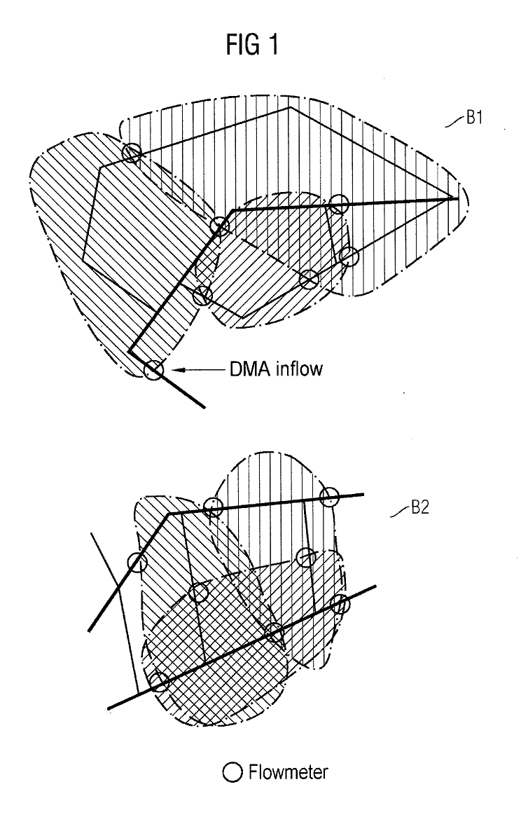

FIG. 1 shows two exemplary embodiments B1, B2 for areas DMA in accordance with the invention. An area DMA may be a physically spatial area of the supply network or a virtual zone. Virtual district meter areas (virtual DMAs) differ from conventional areas (DMAs) as follows. When subdividing the supply network into areas (DMAs), an attempt was always conventionally made to form them such that only one inflow or inflow pipe resulted and can be monitored using a single sensor. In the supply zones, additional flow sensors are installed at selected points such that parts of the network result, the inflows and outflows of which can be measured. These parts should have a common element. The parts are intended to be superimposed and to have common flowmeters. Such parts are referred to as virtual zones or virtual DMAs.

The procedure of creating virtual zones (virtual areas) presents a universal method of subdividing supply networks such that subareas, such as one or more line sections, can be repeatedly monitored with respect to leak detection. The monitoring of each virtual zone functions according to the same principle and can accordingly be repeatedly used in a technical solution. The subdivision of a network into virtual zones provides the advantage that, apart from the installation of flowmeters, there is no need to make any change to the existing network. Another advantage is that the leak detection process can run in an automated manner without disrupting the operation of the supply network or carrying out laborious, cost-intensive measurements in situ.

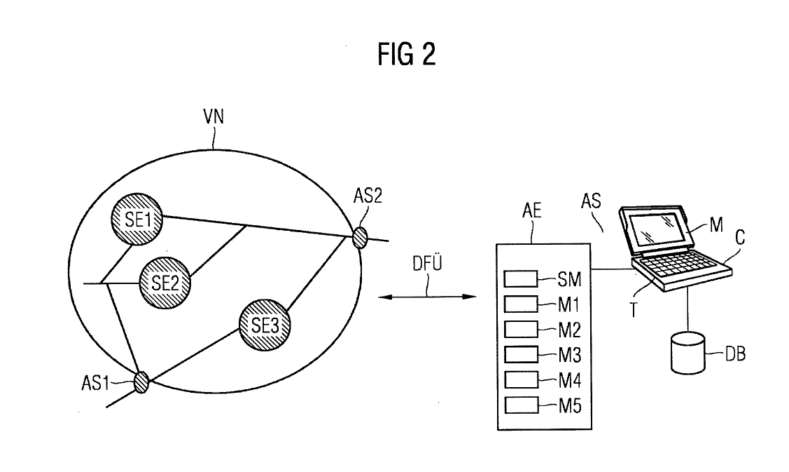

FIG. 2 shows an exemplary basic illustration of a supply network VN with an assistance system AS for monitoring the supply network VN. The supply network VN has sensors connected to the assistance system AS via remote data transmission DFÜ. The assistance system AS is a computer-aided simulation-based assistance system AS for detecting leaks in the supply network VN. Actual measured values are recorded via sensors SE1-SE3, which are installed in a stationary manner at hydraulically selected sensor measuring points within an area of the supply network VN, and are transmitted to an evaluation device AE via remote data transmission DFÜ. The water consumption for an area (DMA, FIG. 1) of the supply network VN under consideration is determined within one or more stipulated measuring periods via the flowmeters AS1, AS2 at the inflows and outflows of the area or supply network. The measured values from the sensors AS1, AS2 may also be transmitted to an evaluation device AE via remote data transmission DFÜ. The actual measured values are compared with values calculated by a Monte Carlo simulation in the evaluation device AE. Discrepancies indicate the presence of a leak. The method may, in principle, be performed at the area level or at the supply network level.

In particular, the evaluation device AE comprises means M1 for determining the water consumption for each area DMA within a stipulated measuring period via the installed sensors, means M2 for mapping the topology of the supply network in a hydraulic simulator and creating a hydraulic simulation model for each area DMA, means M3 for determining the consumption profiles of the consumers connected in the areas DMA, means M4 for determining the flow behavior in the supply network within the stipulated measuring period via Monte Carlo simulation, and means M5 for comparing the measured values determined by the Monte Carlo simulation with the measured values provided by the sensors to detect possible leaks in an area DMA in the event of discrepancies. In this case, the topology of the supply network VN is simulated in a hydraulic simulator. The pipes are parameterized using the known physical values. In contrast, the consumers at the nodes of the network are unknown. A stochastic equivalent model is set up for this purpose.

The computer-aided assistance system AS can be produced using commercially available means. For example, the corresponding sensors SE1-SE3 (for example flowmeters) are available in corresponding specialist shops, and the means for calculating, determining and comparing can be implemented on personal computers C and corresponding software (such as table calculation, mathematical, or simulation programs). In order to generate automatic countermeasures or to display measures for the operating personnel, the assistance system AS may be based, for example, on model-based techniques (for example, CBR, i.e., Case Based Reasoning). Discrepancies between the actual and expected values (simulation results) can be displayed on an output unit M (e.g., a screen) of a computer C. The computer C also comprises storage media, such as a database DB for storing or buffering the measured values from the sensors SE1-SE3 arriving via the remote data transmission line DFÜ.

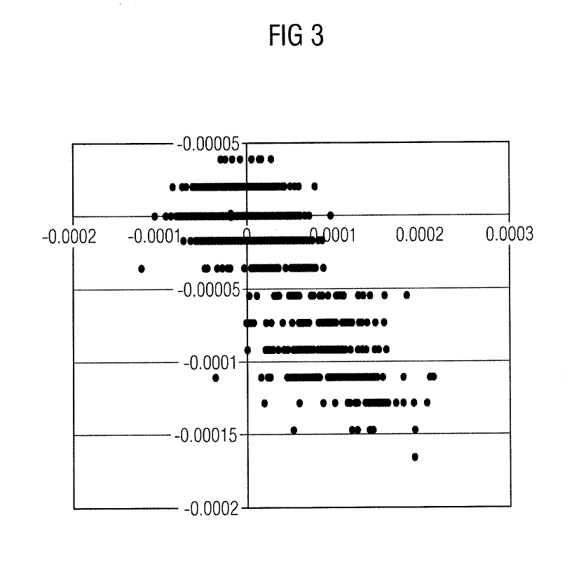

FIG. 3 shows an exemplary illustration of sensor measured values and calculated values for detecting a leak. For this purpose, the measured values from sensors inside the zone (area, DMA) under consideration are depicted against the values calculated by the simulation, as illustrated in the image according to FIG. 3. The deviation of the best-fit line through the point cloud from identity is an indicator that the model does not fit the measurements, which indicates a leak. It is clear to the person skilled in the art that different types of diagrams can be used to illustrate discrepancies.

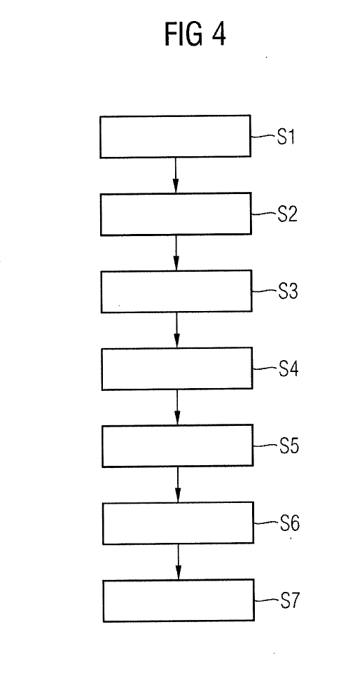

FIG. 4 shows an exemplary flowchart for performing the method in accordance with the invention. In this case, steps S1-S7 are advantageously performed in a computer-aided manner with suitable software (such as table calculation programs, or simulation programs), for example, in a control room.

Additional sensors that do not necessarily define further zones or (virtual) DMAs are placed in a zone/area (for example a virtual DMA) with a known inflow. As is customary in leak detection, the consumption in a low-consumption period of time, such as from 2 to 4 a.m., is again considered (night flow analysis). A hydraulic model is now set up for the zone/area (for example a virtual DMA) based the measured inflow into the zone (DMA). For this purpose, the topology of the network is simulated in a hydraulic simulator. The pipes are parameterized using the known values. In contrast, the consumers at the nodes of the network are unknown. A stochastic equivalent model is set up for this as follows:

The water consumption in the zone is randomly distributed to all consumers for each measuring period. The distribution of the consumption is described in algorithm 1. A hydraulic simulation of the network section is performed using this consumption. For a hydraulic simulation, boundary conditions must be set such that the physical model is meaningfully described: if the zone has only one inflow/outflow, a constant pressure is set at this point, and, if the zone has a plurality of inflows and outflows, a constant pressure is set at one of them and the measured inflows and outflows are set at the others. The mass balancing is therefore correct.

The Monte Carlo simulation using different events of the random distribution of the measured values is used to calculate the calculated sensor values from the internal sensors of the zones. The discrepancy between the measured values and the calculated values indicates possible leaks.

In step S1, the supply network is divided into areas (DMA) each with a known inflow. This can be effected in a computer-aided manner based on models of the network or based on empirical values.

In step S2, flowmeters are installed in a stationary manner at inflows and outflows of an area (DMA). When installing the sensors, it is possible to access sensors that have already been installed, or new sensors are installed depending on the intersection of the areas (DMA). The measured values from the sensors can be reported to a control room for further processing, such as via remote data transmission, radio or satellite link.

In step S3, the water consumption for each area (DMA) is determined within a stipulated measuring period via the flowmeters. This is also advantageously effected in a computer-aided manner.

In step S4, the topology of the supply network is mapped in a hydraulic simulator and a hydraulic simulation model is created for each area (DMA). This is also advantageously effected in an automatic and computer-aided manner.

In step S5, the random consumptions of the consumers connected in the areas (DMA) are determined. This is advantageously effected via software programs.

In step S6, the flow behavior in the supply network is determined within the stipulated measuring period via Monte Carlo simulation. The Monte Carlo simulation is effected by means of a simulation program.

In step S7, it is determined whether there is a leak by comparing the measured values determined by the Monte Carlo simulation with measured values provided by the sensors. The comparison is effected in a computer-aided manner and discrepancies that may be indicators of a leak are advantageously graphically displayed.

Countermeasures (such as closing intake valves, or activating diversions) can be automatically initiated on the basis of the discrepancies, or possible countermeasures can be proposed to the operating personnel of a control room.

### Algorithm 1 for Determining the Random Consumptions:

1) Classifying the consumers: different consumers have a different consumption profile. These profiles indicate how the daily total consumption of a consumer can be mapped to the day. Residential buildings therefore have a different consumption behavior to office buildings, schools or SMEs. Consumers who cannot be classified must be measured exactly and are disregarded in the further description.
2) A theoretical total consumption in the zone can be determined based on the average daily consumption of each consumer which is obtained, for example, using the year-end settlement. For this purpose, a theoretical consumption is calculated for all consumers during the nighttime measuring period based on their average daily consumption and their consumption profile. A theoretical total consumption is calculated therefrom.
3) For initialization, the consumption of all consumers is set to 0 for the entire observation period. In addition, a small quantity of water Q which is subsequently distributed (for example 31) is stipulated; this quantity should be considerably smaller than the minimum water consumption in the zone (DMA).
4) The total consumption of the zone is measured for each period of time of the measuring period (generally 1-3 minutes).
5) Consumers are now randomly selected: the probability of selecting a consumer is his proportion of the total consumption determined in 2). The consumption of the consumer is increased by Q for this period of time.
6) As long as the total water consumption distributed for the observation period is smaller than that determined in 4), go to 5).
7) Repeat steps from 4) for the next measuring period.

The flow behavior for the period of the night flow analysis is now simulated using the random consumption constructed above. A Monte Carlo simulation (as described, for example, in Kurt Binder [et al.], Monte Carlo methods in statistical physics, Springer, Berlin 1979) is performed for this purpose. For this purpose, the simulation is performed for a large selection of random consumptions constructed as described above, and the behavior in the zone is inferred from the large number of simulation values. For this purpose, the measured values from sensors inside the zone under consideration are depicted against the calculated values, as can be seen in the following image. The deviation of the best-fit line through the point cloud from identity is an indicator that the model does not fit the measurements, which indicates a leak (see FIG. 3).

Alternatively, the random flows can also be distributed to the consumers using the following algorithm 2. This is equivalent to the method described above but is distinguished by a shorter delay time since fewer random numbers are picked.

### Algorithm 2 for Determining the Random Consumptions:

Given: quantum quantity Q
Initialize: R=measured total consumption (as an integer multiple of the quantum quantity Q)
G=sum of the average consumptions V(n) of all nodes

### Loop Through the Nodes:

select the next consumption node n which has not yet been dealt with and has an average consumption v(n);
pick the random variable X(n) with a value between 0 and R and the distribution P(X(n)=k)=V(n)^{k}*(G−V(n))^{(R-k)}*R!/(G^{R}*k!*(R−k)!);
replace G with G−V(n) and R with R−X(n);
select the next node until the value X(n) has been determined for each node n.

This algorithm can be used in the case of identical consumption profiles of all consumers. The algorithm allows efficient calculation.

Method, apparatus and assistance system for detecting leaks in an area of a supply network are thus provided, in which case leaks are detected by comparing actual measured values provided by sensors with measured values determined via a Monte Carlo simulation. The method in accordance with disclosed embodiments of the invention for detecting leaks determines, in particular, irregularities, which can be attributed to leaks, for example, based on a hydraulic analysis. Already existing leaks can be detected as a result. In addition, the method in accordance with disclosed embodiments can also be applied to sensors temporarily fitted in the network, which provides the network operator with additional freedom when searching for leaks. The method in accordance with disclosed embodiments can also be used for other supply networks and infrastructures.

Thus, while there have shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-11. (canceled)

12. A computer-aided method for detecting leaks in an area of a supply network, comprising:
a) installing flowmeters in a stationary manner at inflows and outflows of the area;
b) installing sensors for determining one of a flow rate and water pressure within the area;
c) determining an amount of water consumed for the area within at least one stipulated measuring period via the flowmeters at the inflows and outflows and measured values from the sensors within the area;
d) mapping a topology of the supply network in a hydraulic simulator and creating a hydraulic simulation model for the area;
e) determining the amount of water consumed within the area via random stipulation using the consumption profiles and the inflows and outflows of the area;
f) calculating a flow behavior and pressure behavior in the supply network within a stipulated measuring period of the at least one stipulated measuring period via Monte Carlo simulation; and
g) comparing results determined by the Monte Carlo simulation with the measured values provided by the sensors within the area to determine whether leaks are detected.

13. The method as claimed in claim 12, wherein the area comprises a virtual district meter area.

14. The method as claimed in claim 12, wherein the measuring period is from at least one of 2:00 to 4:00, from 0:00 to 24:00 and from 6:00 to 18:00.

15. The method as claimed in claim 12, wherein said step e) comprises determining the consumption profiles of consumers connected in the areas and is performed using a sequence comprising:
(i) classifying the consumers based on an associated average daily consumption;
(ii) determining a theoretical total consumption for each consumer based on a respective average daily consumption and a consumption determined within the stipulated measuring period;
(iii) stipulating a quantity of water Q which is considerably smaller than the minimum water consumption in an area and setting the consumption to 0 (initialization) for all consumers in the supply network;
(iv) dividing the stipulated measuring period into periods of time and measuring a total consumption per area in each period of time;
(v) randomly selecting consumers for each period of time and increasing the consumption of randomly selected consumers by the stipulated quantity of water Q in a respective period of time;
(vi) return to step (v) if a total water consumption distributed for an observation period is smaller than the consumption determined in step (iv); and
(vii) repeating steps from (iv) to (vi) until all periods of time have been processed.

16. The method as claimed in claim 12, wherein the method is implemented with uniform consumer profiles, wherein said step e) comprises determine the consumption profiles of the consumers connected in the areas and is performed out using a sequence comprising:
(i) stipulating n consumption nodes in the supply network;
(ii) stipulating a quantum quantity Q which is substantially smaller than a minimum lever of water consumption in the area;
(iii) stipulating a measured total consumption R as an integer multiple of the quantum quantity Q;
(iv) stipulating a sum G of an average consumptions V(n) of all nodes; and
(v) selecting a next unprocessed consumption node n having an average consumption v(n), retrieving a random variable X(n) having a value between 0 and R and a distribution P(X(n)=k)=V(n)^{k}*(G−V(n))^{(R-k)}*R!/(G^{R}*k!*(R−k)!), and replacing G with G−V(n) and R with R−X(n) for all consumption nodes n, until a value X(n) is determined for each node n of the nodes.

17. The method as claimed in claim 12, further comprising:
repeating steps e) and f) for a fixed interval of time and averaging calculation results before perform said comparison in accordance with step g).

18. The method as claimed in one of claim 12, wherein the method is implemented in an infrastructure network to transport a fluid.

19. The method as claimed in claim 18, wherein the infrastructure network comprises one of a water supply, a gas supply and a district heating network.

20. A computer-aided apparatus for detecting leaks in an area of a supply network, the apparatus comprising:
a) sensors for measuring a respective minimum inflow for each area within a stipulated measuring period;
b) means for determining a level of water consumption for each area within a stipulated measuring period via the installed sensors;
c) means for mapping a topology of the supply network in a hydraulic simulator and for creating a hydraulic simulation model for each area;
d) means for determining consumption profiles of consumers connected in each area;
e) means for determining a flow behavior in the supply network within the stipulated measuring period via Monte Carlo simulation; and
f) means for comparing measured values determined by the Monte Carlo simulation with measured values provided by the sensors to determine whether leaks are detected.

21. The apparatus as claimed in claim 20, further comprising:
output means for at least one of (i) presenting the comparison of the measured values determined by the Monte Carlo simulation with the measured values provided by the sensors and (ii) presenting indicators of a leak.

22. A computer-aided simulation-based assistance system for detecting leaks in an area of a supply network, the system comprising:
an evaluation device; and
sensors installed in a stationary manner, measured values being recorded by the sensors for measuring a minimum inflow of the area within a stipulated measuring period and being transmitted to the evaluation device via remote data transmission,
wherein the evaluation device comprises:
means for determining water consumption for each area within a stipulated measuring period via the installed sensors;
means for mapping a topology of the supply network in a hydraulic simulator and for creating a hydraulic simulation model for each area;
means for determining the consumption profiles of the consumers connected in the areas;
means for determining the flow behavior in the supply network within the stipulated measuring period via Monte Carlo simulation; and
means for comparing measured values determined by the Monte Carlo simulation with measured values provided by the sensors to detect possible leaks in an area in an event of discrepancies.
